(19) United States
(12) Patent Application Publication
(10) Pub. No.: US 2014/0317004 A1
(43) Pub. Date: Oct. 23, 2014

(54) SYSTEMS AND METHODS FOR MANAGING DIGITAL ASSETS

(71) Applicant: AOL Inc., Dulles, VA (US)

(72) Inventors: Travis A. WALKER, South Riding, VA (US); Shawn CARNELL, Berryville, VA (US); Stephanie VAUGHN HAPKE, Saint Charles, MO (US); Edward DEEGAN, Dublin (IE); Patrick FITZSIMONS, CO. Wicklow (IE)

(21) Appl. No.: 14/256,622

(22) Filed: Apr. 18, 2014

Related U.S. Application Data
(60) Provisional application No. 61/814,134, filed on Apr. 19, 2013.

(51) Int. Cl. G06Q 30/00

(52) U.S. Cl. CPC G06Q 30/018
USPC 705/317

(57) ABSTRACT

Computer-implemented systems and methods are provided for tracking the usage of digital assets is disclosed. In one implementation, a method is provided that comprises sending a request to a digital asset management system to acquire a digital asset from a digital asset provider and receiving an asset identifier for the digital asset from the digital asset management system. The method also includes sending the asset identifier to a content management system and receiving publication information from the content management system. In addition, the method includes tracking the publication of the digital asset based on the publication information.

### CROSS-REFERENCE TO RELATED APPLICATION(S)

This application claims the benefit of U.S. Provisional Application No. 61/814,134, filed Apr. 19, 2013, which is incorporated herein by reference in its entirety.

### BACKGROUND

1. Technical Field

The present disclosure relates generally to computer-implemented systems and methods for managing digital assets, such as online content, multimedia, images, videos files, audio files, and other digital assets. More particularly, and without limitation, the present disclosure relates to systems and methods for tracking the acquisition and/or publication of digital assets by consumers.

2. Background

Various solutions exist for providing and managing digital assets. For example, there are a number of consumer products available, both commercially and by open source, that perform one or more digital asset management functions. Such solutions, however, lack integration with online digital asset providers. The problem exists because, among other things, digital asset providers (e.g. Getty, Associated Press, Alamy, etc.) may already have their own websites available for consumers. Typically, a consumer is expected to log in to the digital asset provider's website and perform a purchase and download of an asset to their computer. The consumer may then manually interact with their internal digital asset management system, if present.

Conventional approaches, such as those noted above, can create a wide gap between the tracking of the purchase and/or consumption of digital assets, and managing them centrally as an organization. Such solutions also suffer from other drawbacks or disadvantages, such as the lack of accountability for purchases, poor asset tracking, and/or incomplete reporting.

Moreover, some digital asset management solutions tend to focus on organizations that produce and manage their own assets internally and are not optimized for consumers who have access to a range of external resources and the need for a reliable way to track and manage a wide variety of digital assets.

In view of the foregoing, there is a need for improved systems and methods for managing digital assets. There is also a need for improved systems and methods for managing digital assets that overcome one or more of the above-identified deficiencies and drawbacks of conventional solutions.

### SUMMARY

Consistent with the present disclosure, systems and methods are provided for managing digital assets. Among other things, the present disclosure embodiments for providing systems and methods that are capable of tracking the acquisition and/or publication of digital assets by consumers.

In accordance with some embodiments, a computer-implemented method for tracking the usage of digital assets is disclosed. The method may comprise sending a request to a digital asset management system to acquire a digital asset from a digital asset provider and receiving an asset identifier for the digital asset from the digital asset management system. The method may also comprise sending the asset identifier to a content management system and receiving publication information from the content management system. In addition, the method may comprise tracking the publication of the digital asset based on the publication information.

In accordance with still further embodiments, a system is disclosed. The system may comprise a display device. The system may comprise at least one processor. The system may comprise a memory device that stores a set of instructions that, when executed by the at least one processor, cause the at least one processor to send a request to a digital asset management system to acquire a digital asset from a digital asset provider and receive an asset identifier for the digital asset from the digital asset management system. The set of instructions may further cause the at least one processor to send the asset identifier to a content management system and receive publication information from the content management system. In addition, the set of instructions may further cause the at least one processor to track the publication of the digital asset based on the publication information.

Another embodiment of the present disclosure includes a non-transitory computer-readable medium storing a set of instructions which, when executed by at least one processor, causes the at least one processor to send a request to a digital asset management system to acquire a digital asset from a digital asset provider and receive an asset identifier for the digital asset from the digital asset management system. The set of instructions may further cause the at least one processor to send the asset identifier to a content management system and receive publication information from the content management system. In addition, the set of instructions may further cause the at least one processor to track the publication of the digital asset based on the publication information.

Before explaining certain embodiments of the present disclosure in detail, it is to be understood that the disclosure is not limited in its application to the details of construction and to the arrangements of the components set forth in the following description or illustrated in the drawings. The disclosure is capable of embodiments in addition to those described and of being practiced and carried out in various ways. Also, it is to be understood that the phraseology and terminology employed herein, as well as in the abstract, are for the purpose of description and should not be regarded as limiting.

As such, those skilled in the art will appreciate that the conception and features upon which this disclosure is based may readily be utilized as a basis for designing other structures, methods, and systems for carrying out the several purposes of the present disclosure. It is important, therefore, to recognize that the claims should be regarded as including such equivalent constructions insofar as they do not depart from the spirit and scope of the present disclosure.

### BRIEF DESCRIPTION OF THE DRAWINGS

The accompanying drawings, which are incorporated in and constitute a part of this specification, illustrate several embodiments of the present disclosure and together with the description, serve to explain the principles of the disclosed embodiments.

FIG. 1 depicts a block diagram of an exemplary system environment in which embodiments consistent with the present disclosure may be practiced and implemented;

FIG. 2 depicts an exemplary process for acquiring a Digital Rights User Identifier, consistent with embodiments of the present disclosure;

FIG. 3 depicts an exemplary process for searching for digital assets, consistent with embodiments of the present disclosure;

FIG. 4 depicts an exemplary process for acquiring one or more digital assets, consistent with embodiments of the present disclosure; and

FIG. 5 depicts an exemplary process for retrieving and publishing one or more digital assets, consistent with embodiments of the present disclosure.

### DETAILED DESCRIPTION OF EXEMPLARY EMBODIMENTS

Reference will now be made in detail to exemplary embodiments, examples of which are illustrated in the accompanying drawings. Wherever possible, the same reference numbers will be used throughout the drawings to refer to the same or like parts.

Embodiments herein include computer-implemented methods, tangible non-transitory computer-readable mediums, and systems. The computer-implemented methods may be executed, for example, by at least one processor that receives instructions from a non-transitory computer-readable storage medium. Similarly, systems consistent with the present disclosure may include at least one processor and memory, and the memory may be a non-transitory computer-readable storage medium. As used herein, a non-transitory computer-readable storage medium refers to any type of physical memory on which information or data readable by at least one processor may be stored. Examples include random access memory (RAM), read-only memory (ROM), volatile memory, nonvolatile memory, hard drives, CD ROMs, DVDs, flash drives, disks, and any other known physical storage medium. Singular terms, such as “memory” and “computer-readable storage medium,” may additionally refer to multiple structures, such a plurality of memories and/or computer-readable storage mediums. As referred to herein, a “memory” may comprise any type of computer-readable storage medium unless otherwise specified. A computer-readable storage medium may store instructions for execution by at least one processor, including instructions for causing the processor to perform steps or stages consistent with an embodiment herein. Additionally, one or more computer-readable storage mediums may be utilized in implementing a computer-implemented method. The term “computer-readable storage medium” should be understood to include tangible items and exclude carrier waves and transient signals.

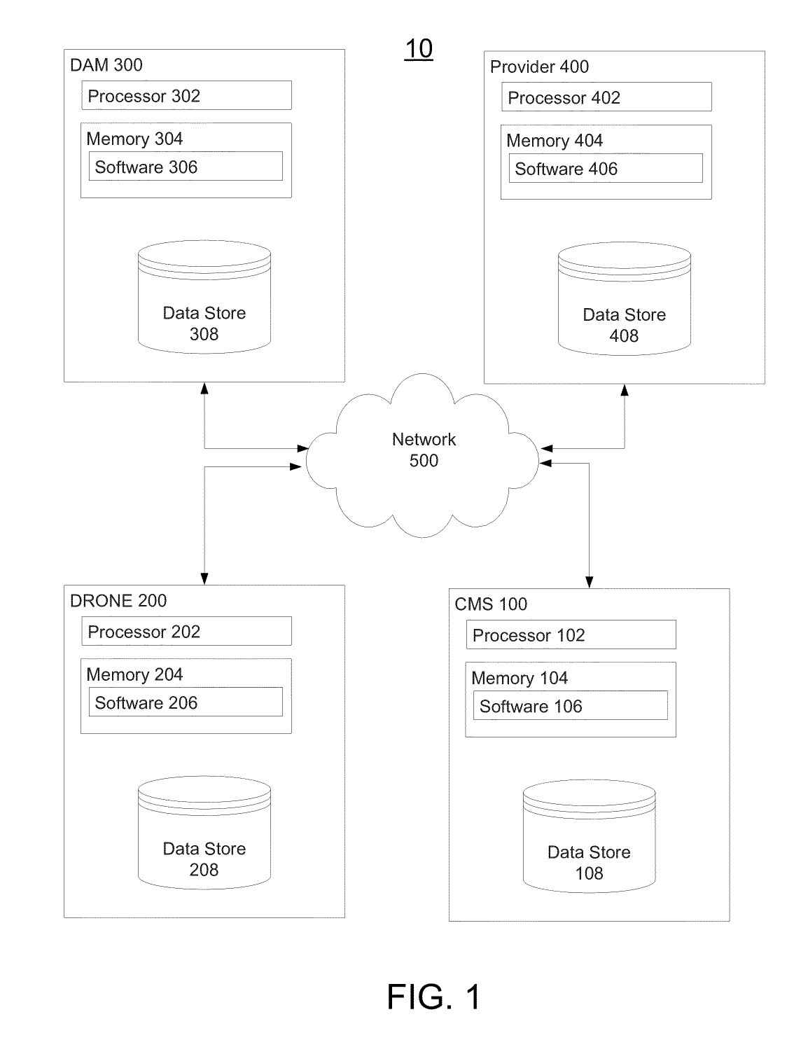

FIG. 1 illustrates an exemplary system environment 10 in which embodiments consistent with the present disclosure may be practiced and implemented. As further disclosed herein, environment 10 of FIG. 1 may be used for managing digital assets, including the purchase or acquisition of digital assets. As used herein, the term “digital asset” refers to all forms of content and information, including that provided electronically or online (e.g., via the Internet). Examples of “digital assets” include any combination of articles, images and video files, music and other forms of audio files or clips (e.g., electronic books or presentations), multimedia, and the like.

As shown in FIG. 1, system environment 10 may include one or more Content Management Systems (“CMS”) 100, Digital Rights Online Systems (“DRONE”) 200, Digital Asset Management Systems (“DAM”) 300, and/or digital asset providers 400. All of the above components of system environment 10 may be disposed for communication with one another via an electronic network 500, such as Internet and/or other communication networks.

As will be described in more detail below, in certain embodiments, CMS 100, DRONE 200, DAM 300, and/or digital asset providers 400 may be configured to send and receive application programming interface (API) requests to and from each other for retrieving data from and interacting with the one or more services provided by each other. An API may be a source code interface that a computer system or library provides in order to support requests from a software application. An API may be specified in terms of a programming language that can be interpretative or compiled when an application is built, rather than an explicit low-level description of how data is laid out in memory. The software that provides the functionality described by an API is said to be an implementation of the API.

CMS 100 may be configured to manage digital assets, This may include, for example, managing digital assets used or provided by one or more sources, such as websites. This may also include the tracking of the acquisition and/or publication of digital assets by consumers or one or more websites. Other functions may also be provided directly or indirectly by CMS 100, such as the searching and identification of digital assets. In some embodiments, CMS 100 provides such functions individually or in combination with other components in system environment 100. CMS 100 may use digital assets in the process of composing online content. For example, in preparing an online new article with related media (e.g., photographs, video, etc.), or creating a slideshow around a topic or event. Additionally, the CMS 100 may manage DRUIDs for the users of the CMS 100.

DRONE 200 may provide one or more services in system environment 10. For example, DRONE 200 may provide CMS 100 with access to one or more online providers of digital assets. As another example, DRONE 200 may provide a service that tracks the publication or usage of digital assets. In yet another example, DRONE 200 may provide a service to CMS 100 that allows assets to be searched and/or acquired.

DAM 300 may manage one or more assets in system 10. For example, DAM 300 may provide a list of asset providers 400. In another example, DAM 300 may acquire and/or track the acquisition of assets from provider 400. In yet another example, DAM 300 may manage permissions for the assets and/or the DRUIDs.

Digital asset provider 400 may provide one or more digital assets. Examples of digital assets include, for example, articles, photos, videos, audio clips, etc. Provider 400 may provide one or more APIs that allow the digital assets to be searched and/or retrieved.

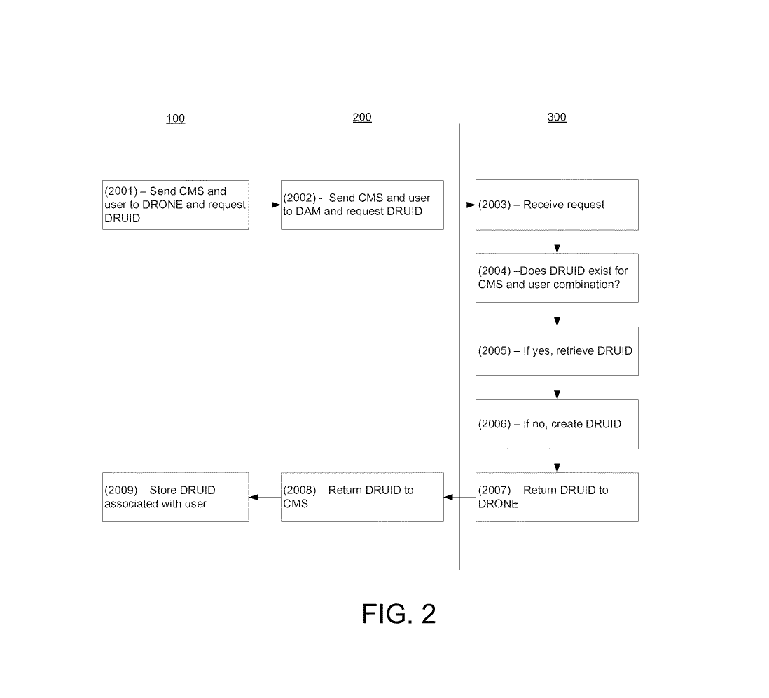

FIG. 2 depicts an exemplary process for acquiring a Digital Rights User Identifier (“DRUID” hereinafter), consistent with embodiments of the present disclosure. A DRUID may be any globally unique identifier. The digital asset system may support multiple authorization systems each with their own body of users. Therefore, an additional ID may need to be generated as a global reference to that user. The exemplary process of FIG. 2 may be implemented using, for example, system environment 10 (FIG. 1). For purposes of illustration, the steps of the exemplary process of FIG. 2 will be described with reference to CMS 100, DRONE 200, and DAM 300.

In step 2001, CMS 100 may send CMS and user information to DRONE 200 to request a DRUID. The CMS and user information may include identification information for the CMS and at least one user or consumer. This may include, for example, an IP address, e-mail address, country, or associated company or entity of the CMS or user. The user identification information may include any combination of information or means for authenticating a user.

In step 2002, DRONE 200 may send the CMS and user information to DAM 300 and request the DRUID. In step 2003, DAM 300 may receive the request. In step 2004. DAM 300 may check if a DRUID exists for the received combination of CMS and user information. If a DRUID exists (e.g., in a local data repository or database), DAM 300 may retrieve the DRUID in step 2005. If a DRUID does not exist, DAM 300 may create a DRUID for the combination of CMS and user information in step 2006. For example, the DRUID may be a combination of a unique CMS identifier and a unique user identifier, The DAM 300 may then return the DRUID to DRONE 200 in step 2007. The DRONE 200 may then return the DRUID to CMS 100 in step 2008. In step 2009, CMS 100 may associate the DRUID with the user and store the DRUID (e.g., in memory or a data repository or database).

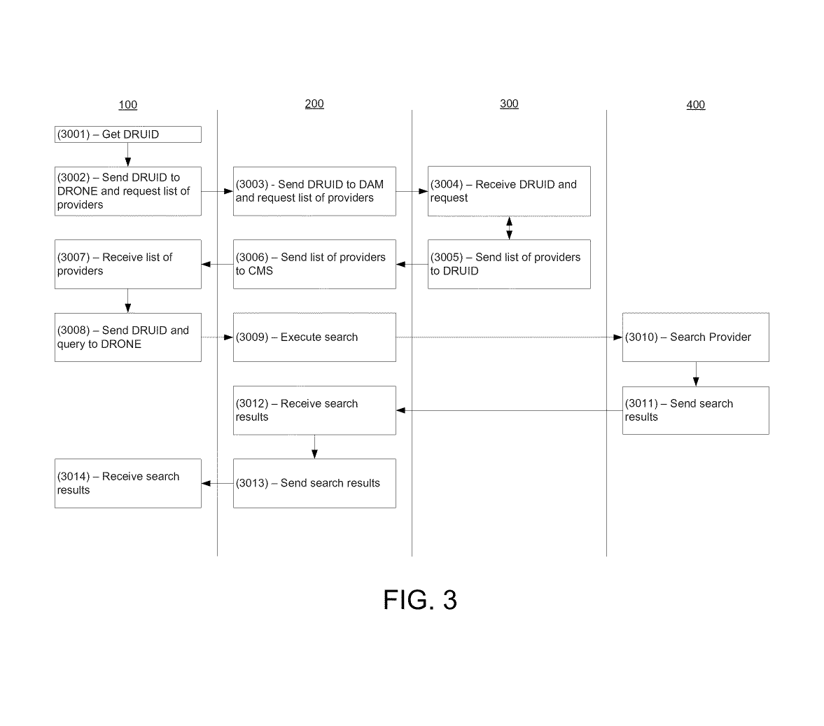

FIG. 3 depicts an exemplary process for searching for digital assets, consistent with embodiments of the present disclosure. As with FIG. 2, the exemplary process of FIG. 3 may be implemented using, for example, system environment 10 (FIG. 1). For purposes of illustration, the steps of the exemplary process of FIG. 3 will be described with reference to CMS 100, DRONE 200, DAM 300, and digital asset providers 400.

In step 3001, CMS 100 may get a DRUID for a user or consumer. This may be achieved, for example, by using the exemplary process of FIG. 2. CMS 100 may then send the DRUID to the DRONE 200 with a request for a list of digital asset providers 400 in step 3002. In step 3003, the DRONE 200 may send the DRUID and request to DAM 300. The DAM 300 may receive the request (step 3004) and retrieve a list of digital asset providers. In one embodiment, the request may include one or more parameters (e.g., requirements or terms related to assets and/or providers) and DAM 300 may retrieve a list of providers that match those parameters. The DAM 300 may then send the list of providers to DRONE 200 in step 3005. The DRONE 200 may then send the list of digital asset providers the CMS 100. The list of providers may be limited, for example, based upon the access rights of the user associated with the DRUID.

Once CMS 100 receives the list of providers (step 3007), the CMS 100 may prepare an asset query. The asset query may include, for example, a selection of one or more providers 400 from the list, a category of providers, one or more asset search terms, and/or one or more asset types. In step 3008, CMS 100 may send the asset query and the DRUID for the user to DRONE 200.

In step 3009, DRONE 200 may execute a search based on the received query. This may include, for example, sending the query to one or more of the providers 400 based on the query parameters. The scope of the search may be limited, for example, based upon the permissions of the user associated with the DRUID. Each provider 400 may then search its assets in step 3010 and send the results to DRONE 200 in step 3011. When DRONE 200 receives the search results from the one or more providers 400 in step 3012, DRONE 200 may send the results to CMS 100. This may include, for example, aggregating search results from multiple asset providers 400. CMS 100 may then receive the search results in step 3014 and provide them to the user.

In some embodiments, the digital assets in the search results will each have a Local Unique ID (“LUID”) that can be used to request acquisition of each asset. This identifier may be local for the provider of the asset. This identifier may represent the global ID of an asset with respect to the provider. Because the digital asset system supports multiple providers, the system may consider this to be a local ID. For example, all external providers may have a unique identifier for each of the assets they provide. In their local system, they may call it an asset ID. The DRONE and/or DAM may require a mapping between their IDs and the LUID. The IDs for the DRONE and/or DAM may be called an asset ID (“ASID”). The ASID may serve as the master unique ID for an asset after it has been ingested into system 10. For example, the ASID may be a combination of a provider identifier and the LUID. Thus, the ASID may represent the global ID of an asset with respect to the digital asset system.

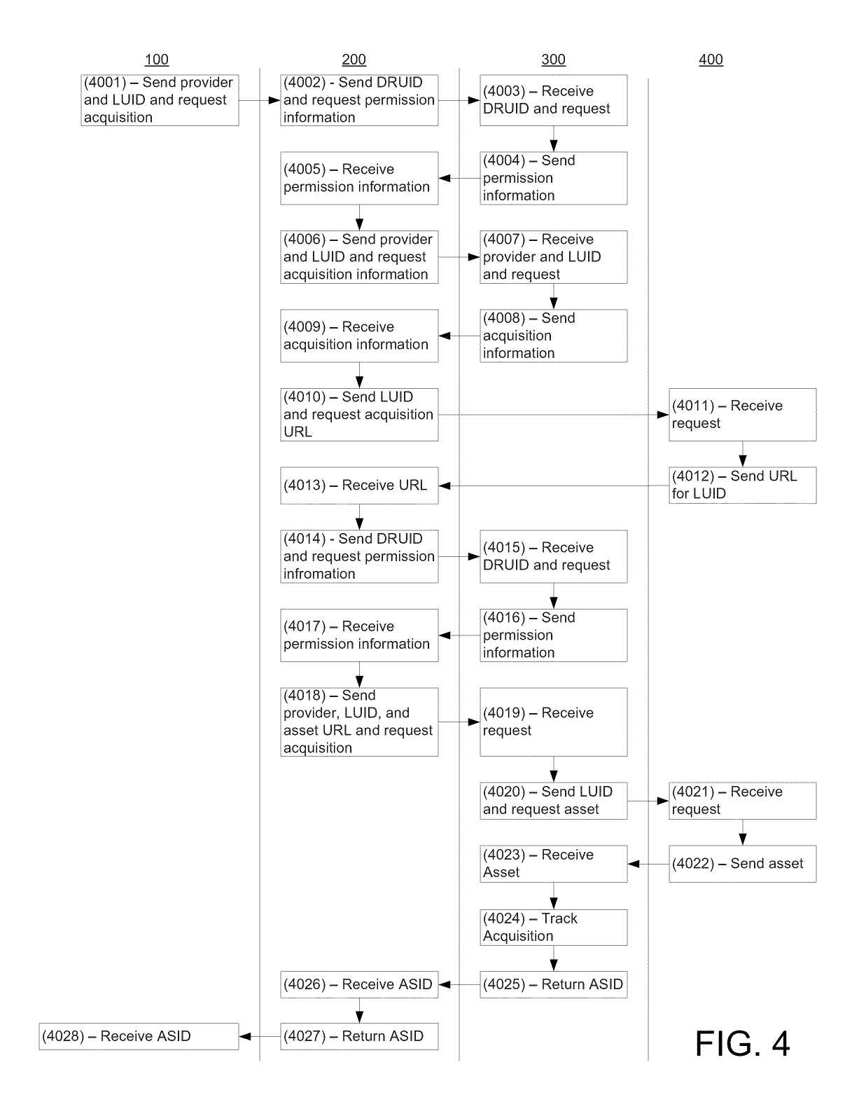

FIG. 4 depicts an exemplary process for acquiring one or more digital assets, consistent with embodiments of the present disclosure. The exemplary process of FIG. 4 may be implemented using, for example, system environment 10 (FIG. 1). For purposes of illustration, the steps of the exemplary process of FIG. 4 will be described with reference to CMS 100, DRONE 200, DAM 300, and digital asset providers 400.

In step 4001, CMS 100 may send a request to DRONE 200 to request an acquisition of one or more digital assets. The request may include, for example, provider information and/or a LUID for one or more items on the list. Before requesting the asset acquisition, DRONE 200 may verify the user's or consumer's permissions. For example, in step 4002, DRONE 200 may send a permissions request that includes the user's DRUID to DAM 300.

In step 4003, DAM 300 may receive the DRUID and request and send the permission information relating to the DRONE 200 in step 4005. The DRONE 200 may then process the permission information to determine if the user is authorized. The permission information may include information indicating which digital assets or providers a DRUID may access. Alternatively, permission information may merely be an indication of whether the DRUID has permission to access a particular asset, type of asset, and/or provider 400.

To facilitate the acquisition, DRONE 200 may need acquisition information. Acquisition information may include information such as, account information, credentials, provider information (e.g., the address of the provider server), etc. DRONE 200 may acquire the acquisition information from DAM 300. For example, in step 4006, DRONE 200 may send a request for acquisition information to DAM 300. The request may include, for example, the provider information and/or one or more LUIDs. In step 4007, DAM 300 may receive the request. The DAM 300 may then, for example, use the provider information and/or the LUID(s) to retrieve the appropriate acquisition information. DAM 300 may then send the acquisition information to DRONE 200 in step 4008.

Once DRONE 200 receives the acquisition information in step 4009, DRONE 200 may use the acquisition information to request an acquisition URL from one or more providers 400 in step 4010. The request may include, for example, the

LUID for each desired asset. In step 4011, each provider 400 may receive the request and then determine an asset URL based on the LUID. Provider 400 may then send the asset URL to DRONE 200 in step 4013. In some embodiments, multiple requests may be sent by DRONE 200 and, depending on the location of the desired assets, the request(s) may be sent to one or more digital asset providers 400.

Once DRONE 200 has the asset URL for a desired asset, DRONE 200 may verify the user's permissions before requesting the acquisition of the asset. For example, DRONE 200 may use a process in steps 4014 to 4017 that is similar to the process outlined above for steps 4002 to 4005.

DRONE 200 may send a request to perform the acquisition to DAM 300 in step 4018. The request may include, for example, provider information, LUID, and/or an asset URL. In step 4019, DAM 300 may receive the request for a desired digital asset. DAM 300 may use the information in the request to acquire the desired assets. For example, in step 4020, DAM 300 may send an asset request to one of the providers 400 using the asset URL. The request may include, for example, the LUID for the requested asset. Once the provider 400 receives the request in step 4021, provider 400 may retrieve the asset associated with the LUID, Provider 400 may then send the asset to DAM 300. The above steps may be repeated for multiple asset requests and, depending on the location of the desired assets, the desired assets may be retrieved and sent to DAM 300 by one or more digital asset providers 400.

In step 4023, DAM 300 may receive a requested digital asset and store the same in the DAM 300. DAM 300 may also track the acquisition in step 4024. This may include logging information such and the DRUID, LUID, provider information, CMS information, and the like. The tracking step may record the “usage” of an asset. For example, some assets are purchased and allow for infinite use (e.g., the asset can be published on any site, to any audience, as many times as you want). Other assets may have legal terms around how many times they can be published, on which devices they are allowed to surface, and in which manner they are allowed to be syndicated (RSS for example). The tracking step may capture the assets usage trail, so that the user may know, for example, the image (cdn) link where the asset can be accessed on the web, and all the sites and specific pages where that image will be referenced and displayed to a user.

Once the DAM 300 has acquired a digital asset, the DAM 300 may send the ASID for the asset to DRONE 200 in step 4025. Once DRONE 200 receives that ASID in step 4026, in may provide it to the CMS 100 in step 4027. CMS 100 may then receive and store the ASID in step 4028.

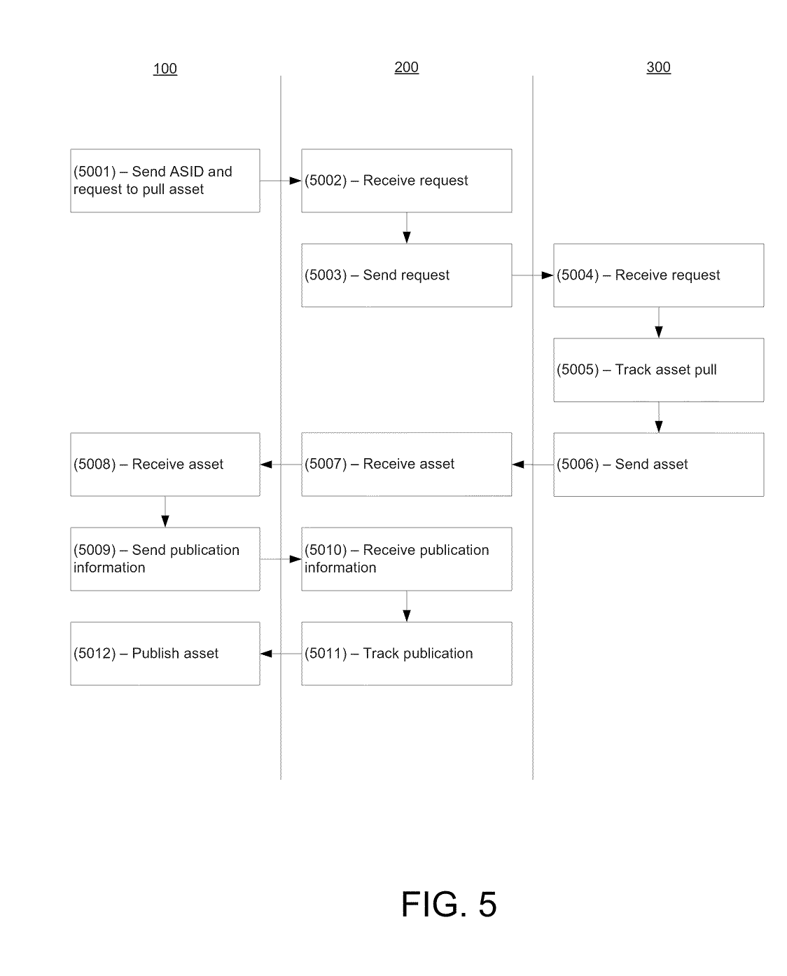

Once the DAM 300 has acquired an asset, the user or consumer may retrieve or download the asset using the ASID. An exemplary process for pulling and publishing an asset is described below with reference to FIG. 5.

FIG. 5 depicts an exemplary process for retrieving and publishing one or more digital assets, consistent with embodiments of the present disclosure. The exemplary process of FIG. 5 may be implemented using, for example, system environment 10 (FIG. 1). For purposes of illustration, the steps of the exemplary process of FIG. 5 will be described with reference to CMS 100, DRONE 200, DAM 300, and digital asset providers 400. Further, while the following description provides an example of retrieving or downloading one digital asset, it will be appreciated that the exemplary steps may be repeated or otherwise adapted to retrieve more than one digital asset, as needed.

In step 5001, CMS 100 may send a request to retrieve or pull a digital asset to DRONE 200. The request may include, for example, the ASID for the desired digital asset. In steps 5002 and 5003, DRONE 200 may receive the request and send it to DAM 300. Once DAM 300 receives the request in step 5004, DAM 300 may track the asset pull in step 5005 and send the requested asset to DRONE 200 in step 5006.

In step 5007, DRONE 200 may receive the digital asset and then provide it to CMS 100. Once CMS 100 receives the asset in step 5008, it may provide the requested digital asset to the user or consumer. For example, the user may view or playback the digital asset or otherwise use or publish the digital asset (e.g., integrate the digital asset into one or more websites).

For example, when the user is ready to publish a digital asset (or content included in the asset), CMS 100 may send publication information to DRONE 200 in step 5009. Publication information may include for example, the locations where the asset is published, the types of devices it will be published on, how it will be syndicated, the number of accesses, the locations (e.g., counties) in which the asset is or can be accessed, etc. This information may be used, for example, to ensure compliance with one or more terms under which the provider will provide the asset. In steps 5010 and 5011, DRONE 200 may receive the publication information and track the publication of the asset. Then, CMS 100 may publish the asset in step 5012.

The system of FIG. 1 may include one or more server systems, databases, and/or computing systems configured to receive information from entities in a network, process the information, and communicate the information with other entities in the network. In certain embodiments, the system of FIG. 1 may be configured to receive data over an electronic network, such as the Internet, process/analyze the content, and provide the content to one or more applications.

The various components of the system of FIG. 1 may include an assembly of hardware, software, and/or firmware, including memory, a central processing unit (“CPU”), and/or a user interface. For example, memory 104, 204, 304, and 404 may include any type of RAM or ROM embodied in a physical storage medium, such as magnetic storage including floppy disk, hard disk, or magnetic tape; semiconductor storage such as solid state disk (“SSD”) or flash memory; optical disc storage; or magneto-optical disc storage. These memories may store temporary data or information, as well as executable or persistent copies of software and/or instructions to be executed by one or more processors.

In the exemplary embodiment of FIG. 1, a CPU may include one or more processors 102, 202, 302, and 402 for processing data according to a set of programmable instructions or software stored in memory (e.g., software 106, 206, 306, and 308). The functions of each processor may be provided by a single dedicated processor or by a plurality of processors. Moreover, processors may include any type or combination of input/output devices, such as a display monitor, keyboard, touch screen, and/or mouse. System 10 may be implemented using one or more technologies such as JAVA, Apache/Tomcat, jQuery, etc.

The system of FIG. 1 may also include or connect to one or more data repositories (“databases”) 108, 208, 308, and 408, which may store data for managing assets, one or more digital assets, etc. For example, these data repositories or databases may store CMS and user information and/or DRUIDs, as disclosed herein. These data repositories or databases may also store temporary data or information, as well as executable or persistent copies of software and/or instructions to be executed by one or more processors.

The system environment 10 of FIG. 1 may also include any combination of content management, digital asset management, and/or any other software or set of instructions. Such software and/or set of instructions may implement or support any number of the processes, features, and interfaces disclosed herein. In another embodiment, the software may include a set of instructions executable by one or more processors to provide the methods, features, and interfaces described herein.

In FIG. 1, network 500 may include one or more wide area networks (WANs), metropolitan area networks (MANs), local area networks (LANs), or any combination of these networks. Network 500 may include a combination of a variety of different network types, including Internet, Ethernet, twisted-pair, coaxial cable, fiber optic, cellular, wireless, satellite, IEEE 802.11, terrestrial, and/or other types of network connections. In some embodiments, network 500 comprises the Internet.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments. For example, systems and methods consistent with the disclosed embodiments may be implemented as a combination of hardware and software or in hardware alone.

Examples of hardware include computing or processing systems, including personal computers, laptops, mainframes, micro-processors and the like. Additionally, although aspects are described for being stored in memory, one skilled in the art will appreciate that these aspects can also be stored on other types of computer-readable media, such as secondary storage devices, for example, hard disks, floppy disks, or CD-ROM, or other forms of RAM or ROM.

Programmable instructions, including computer programs, based on the written description and disclosed embodiments are within the skill of an experienced developer. The various programs or program modules may be created using any of the techniques known to one skilled in the art or may be designed in connection with existing software. For example, program sections or program modules may be designed in or by means of C#, Java, C++, HTML, XML, CSS, JavaScript, or HTML with included Java applets. One or more of such software sections or modules may be integrated into a computer system or browser software or application.

In some embodiments disclosed herein, some, none, or all of the logic for the above-described techniques may be implemented as a computer program or application or as a plug-in module or subcomponent of another application. The described techniques may be varied and are not limited to the examples or descriptions provided.

The foregoing description has been presented for purposes of illustration. It is not exhaustive and is not limiting to the precise forms or embodiments disclosed. Modifications and adaptations will be apparent to those skilled in the art from consideration of the specification and practice of the disclosed embodiments.

The claims are to be interpreted broadly based on the language employed in the claims and not limited to examples described in the present specification, which examples are to be construed as non-exclusive, Further, the steps of the disclosed methods may be modified in any manner, including by reordering steps and/or inserting or deleting steps.

It is intended, therefore, that the specification and examples be considered as exemplary only. Additional embodiments are within the purview of the present disclosure and the claims.

What is claimed is:

1. A computer-implemented method for tracking the usage of digital assets, the method comprising:
sending a request to a digital asset management system to acquire a digital asset from a digital asset provider:
receiving an asset identifier for the digital asset from the digital asset management system;
sending the asset identifier to a content management system;
receiving publication information from the content management system; and
tracking the publication of the digital asset based on the publication information.

2. The method of claim 1, wherein tracking the publication of the digital asset includes storing a digital rights user identifier associated with the publication.

3. The method of claim 1, wherein the digital asset comprises at least one of an article, a photo, a video, or audio content.

4. The method of claim 1 further comprising requesting acquisition information from the digital asset management system.

5. The method of claim 4, wherein the request for acquisition information includes a list unit identifier and information identifying the digital asset provider.

6. The method of claim 5, further comprising sending a request for an asset URL to the digital asset provider based on acquisition information received in response to the request for acquisition information, wherein the asset URL is included in the request to the digital asset management system to acquire the digital asset from the digital asset provider.

7. The method of claim 6, wherein the request to the digital asset management system to acquire the digital asset from the digital asset provider further includes the list unit identifier and the information identifying the digital asset provider.

8. The method of claim 1, wherein the digital asset management system tracks the acquisition of the digital asset from the digital asset provider.

9. A system comprising:
a display device;
at least one processor; and
a memory device that stores a set of instructions that, when executed by the at least one processor, cause the at least one processor to:
send a request to a digital asset management system to acquire a digital asset from a digital asset provider;
receive an asset identifier for the digital asset from the digital asset management system;
send the asset identifier to a content management system;
receive publication information from the content management system; and
track the publication of the digital asset based on the publication information.

10. The system of claim 9, wherein tracking the publication of the digital asset includes storing a digital rights user identifier associated with the publication.

11. The system of claim 9, wherein the digital asset comprises at least one of an article, a photo, a video, or audio content.

12. The system of claim 9, wherein the set of instructions further cause the at least one processor to request acquisition information from the digital asset management system.

13. The system of claim 12, wherein the request for acquisition information includes a list unit identifier and information identifying the digital asset provider.

14. The system of claim 13, wherein the set of instructions further cause the at least one processor to send a request for an asset URL to the digital asset provider based on acquisition information received in response to the request for acquisition information and the asset URL is included in the request to the digital asset management system to acquire the digital asset from the digital asset provider.

15. The system of claim 13, wherein the digital asset management system tracks the acquisition of the digital asset from the digital asset provider.

16. A non-transitory computer-readable medium storing a set of instruction which, when executed by at least one processor, causes the at least one processor to:
send a request to a digital asset management system to acquire a digital asset from a digital asset provider;
receive an asset identifier for the digital asset from the digital asset management system;
send the asset identifier to a content management system;
receive publication information from the content management system; and
track the publication of the digital asset based on the publication information.

17. The computer-readable medium of claim 16, wherein tracking the publication of the digital asset includes storing a digital rights user identifier associated with the publication.

18. The computer-readable medium of claim 16, wherein the set of instructions further cause the at least one processor to request acquisition information from the digital asset management system.

19. The computer-readable medium of claim 18, wherein (i) the request for acquisition information includes a list unit identifier and information identifying the digital asset provider, (ii) the set of instructions further cause the at least one processor to send a request for an asset URL to the digital asset provider based on acquisition information received in response to the request for acquisition information and (ii) the asset URL is included in the request to the digital asset management system to acquire the digital asset from the digital asset provider.

20. The computer-readable medium of claim 16, wherein the digital asset management system tracks the acquisition of the digital asset from the digital asset provider.
